(19) United States
(12) Patent Application Publication
(10) Pub. No.: US 2026/0157401 A1
(43) Pub. Date: Jun. 11, 2026

(54) SOFT CHEW

(71) Applicant: Nutramax Laboratories, Inc., Lancaster, SC (US)

(72) Inventors: David Griffin, Lancaster, SC (US); Binh Davis, Lancaster, SC (US); Hubert Ratkowski, Lancaster, SC (US)

(21) Appl. No.: 18/708,070

(22) PCT Filed: Nov. 11, 2022
(86) PCT No.: PCT/US2022/049717

§ 371 Date: May 7, 2024

Related U.S. Application Data
(60) Provisional application No. 63/278,132, filed on Nov. 11, 2021.

(51) Int. Cl. A23K 20/158; A23K 10/30; A23K 20/121; A23K 40/00; A23K 50/40

(52) U.S. Cl. CPC A23K 20/158; A23K 10/30; A23K 20/121; A23K 40/00; A23K 50/40

(57) ABSTRACT

A soft chew nutritional supplement for an animal, such as a dog or cat, is provided. The soft chew includes (a) palm oil and/or palm oil constituent, (b) palm kernel oil and/or coconut oil, and (c) at least one other oil. The method of manufacturing the soft chew typically includes partially curing the soft chew at −79 to 0° C. before packaging the soft chew, and then allowing the soft chew to fully cure while in the packaging at room temperature. To achieve the desired processing and curing of the soft chew, the ratio of the total amount of the components (a) and (b) to the total amount of the (c) other oil ranges from 45:55 to 55:45. In addition, the components (a) and (b) have a Mettler Dropping Point ranging from 36° C. to 40° C. and are present in an amount of 4.5 wt. % to 6.5 wt. %.

### CROSS REFERENCE TO RELATED APPLICATIONS

This application claims priority to and the benefit of international (PCT) patent application no. PCT/US2022/049717, filed Nov. 11, 2022, which claims priority to U.S. provisional patent application No. 63/278,132, filed Nov. 11, 2021, the entire contents of which is incorporated herein by reference.

### TECHNICAL FIELD

The invention relates generally to a soft chew for oral administration to an animal subject and, in particular, to a nutritional supplement, and a method of manufacturing the soft chew.

### BACKGROUND

A nutritional supplement for oral administration to an animal, such as a dog, cat, or horse, can be provided in the form of a pliable, soft chew or soft chewable tablet, for example a chewable pellet or soft chewable treat. The soft chew may contain a nutritional supplement or active pharmaceutical ingredients, such as one to help modulate the inflammatory response in the connective tissue of an animal. For example, the soft chew can be used for joint health and/or provide joint support to the animal.

Soft chews are typically manufactured by mixing and heating the active and inactive ingredients in a blender to form a dough, forming the dough into the shape of the soft chews using a former or extruder, and fully curing the soft chews to achieve an appropriate firmness before packaging the soft chews. The curing step (starch absorption) is typically conducted at room temperature (18° C. to 26° C.) or at an elevated temperature ranging from 26° C. to 32° C. with controlled humidity ranging from 25% to 30% RH. Typically, the curing step takes at least 24 to 72 hours and thus is an expensive and time-consuming portion of the manufacturing process. After the lengthy curing step, the soft chews are typically packaged in a plastic bag, bottle, or tub. A more efficient method of manufacturing the soft chews is desired.

### SUMMARY

One aspect of the disclosure provides a soft chewable nutritional supplement for an animal subject which can be manufactured by a method that is more efficient than comparative methods used to manufacture soft chews. The soft chew includes (a) at least one of palm oil and palm oil constituent, the palm oil constituent including at least one of stearic acid, palmitic acid, myristic acid, and lauric acid; (b) at least one of palm kernel oil and coconut oil; and (c) at least one other oil. The ratio of the total amount of the component(s) (a) and the component(s) (b) present in the soft chew to the total amount of the component(s) (c) present in the soft chew ranging from 40:60 to 60:40.

Another aspect of the disclosure provides a soft chew for an animal subject, comprising (a) at least one of palm oil and palm oil constituent, the palm oil constituent including at least one of stearic acid, palmitic acid, myristic acid, and lauric acid; (b) at least one of palm kernel oil and coconut oil; and (c) at least one other oil. The amount of the component(s) (a) and the amount of the component(s) (b) being a total amount of 4.5 weight percent (wt. %) to 6.5 wt. %, based on the total weight of the soft chew.

Another aspect of the disclosure provides a method of manufacturing the soft chewable nutritional supplement containing the ratio of the total amount of the component(s) (a) and the total amount of the component(s) (b) to the total amount of the components (c) ranging from 40:60 to 60:60. The method includes at least partially curing the soft chew at a temperature ranging from −79° C. to 0° C. before packaging the soft chew, or curing the soft chew at a temperature ranging from 18° C. to 26° C. for 12 hours to 48 hours before packaging the soft chew.

### DETAILED DESCRIPTION

One aspect of the disclosure provides a soft chew, for example a soft chewable pellet or treat, which is a nutritional supplement for oral administration to an animal, such as a dog, cat, or horse. The soft chew may contain at least one nutritional supplement or active pharmaceutical ingredient, such as one to help modulate the inflammatory response in the connective tissue of an animal. For example, the soft chew can be used for joint health and/or provide joint support to the animal. The method of manufacturing the soft chew includes freezing the soft chew to harden the soft chew prior to packaging, and allowing the soft chew to fully cure in the packaging at room temperature (18° C. to 26° C.), rather than fully curing the soft chew at room temperature or an elevated temperature with controlled humidity before packing the soft chew. Thus, the manufacturing process is more efficient than conventional methods used to manufacture soft chews, as process time and expense is reduced.

The soft chew includes a mixture of active and inactive ingredients. A variety of different ingredients can be used depending on the intended purpose of the soft chew. However, the soft chew is formulated to include palm oil and/or palm oil constituent. The palm oil constituent includes at least one of stearic acid, palmitic acid, myristic acid, and lauric acid. The palm oil consistent may include a combination of two or more of stearic acid, palmitic acid, myristic acid, and lauric acid. However, the palm oil may include different constituents, fewer constituents, or additional constituents. The palm oil and/or palm oil constituent impacts the processing and texture of the soft chew. The soft chew also includes palm kernel oil and/or coconut oil. These oils also impact the processing and texture of the soft chew.

The palm oil, the palm oil constituent, palm kernel oil, and coconut oil are a combination of saturated and unsaturated fatty acids that are solid when stored at recommended temperatures of 18.3° C. to 26.6° C. Different ratios of the (a) palm oil and/or palm oil constituent and the (b) palm kernel oil and/or coconut oil alter the Mettler Dropping Point of the combined (a) palm oil and/or palm oil constituent and (b) palm kernel oil and/or coconut oil. The Mettler Dropping Point is the temperature at which the first drop of the combination of the components (a) and (b) precipitates from a standardized cup with a defined orifice under controlled testing conditions in a furnace. The AOCS Cc 18-80 standard test can be used to determine the Mettler Dropping Point. The combination of the components (a) and (b) is present in an amount that has a Mettler Dropping Point ranging from 36° C. to 44° C. According to other embodiments, the Mettler Dropping Point of the combination of the components (a) and (b) ranges from 30° C. to 50° C., or 26° C. to 75° C. The desired processing and curing of the soft chew is achieved in part due to the Mettler Dropping Point being in the range of 36° C. to 44° C.

In addition to the components (a) and (b), the inactive pharmaceutical ingredients of the soft chew typically include at least one other oil, for example a fish oil or a vegetable oil, such as soybean oil. The total amount of oil present in the soft chew is typically 5 weight percent (wt. %) to 17 wt. %, or 10 wt. % to 13 wt. %, based on the total weight of the soft chew. According to preferred embodiments, the oil present in the components (a) and (b) is only a portion of the total oil present in the soft chew.

According to example embodiments, the ratio of the total amount of the (a) palm oil and/or palm oil constituent and the (b) palm kernel oil and/or coconut oil present in the soft chew to the total amount of the other oil present in the soft chew ranges from 40:60 to 60:40. According to other embodiments, the ratio of the total amount of the (a) palm oil and/or palm oil constituent and the (b) palm kernel oil and/or coconut oil present in the soft chew to the total amount of the other oil present in the soft chew ranges from 40:60 to 60:40, or ranges from 25:75 to 75:25. The desired processing and curing of the soft chew is achieved in part due to the ratio ranging from 40:60 to 60:40.

The total amount of the (a) palm oil and/or palm oil constituent and the (b) palm kernel oil and/or coconut oil present in the soft chew also impacts the processing and curing of the soft chew. According to example embodiments, such as when the soft chew weighs 4.5 grams, the soft chew includes the (a) palm oil and/or palm oil constituent and the (b) palm kernel oil and/or coconut oil in a total amount of 4.5 weight percent (wt. %) to 6.5 wt. %, based on the total weight of the soft chew. According to other embodiments, the amount of the (a) palm oil and/or palm oil constituent and the (b) palm kernel oil and/or coconut oil in a total amount of present in the soft chew ranges from 3.0 wt. % to 10.0 wt. % or 0.2 wt. % to 20.0 wt. %, based on the total weight of the soft chew. The desired processing and curing of the soft chew are achieved in part due to the component(s) (a) and (b) being present in an amount of 4.5 wt. % to 6.5 wt. %, based on the total weight of the soft chew.

The amount of the (a) palm oil and/or palm oil constituent and the (b) palm kernel oil and/or coconut oil also impacts the amount of fatty acids present in the soft chew. For example, when the soft chew includes the (a) palm oil and/or palm oil constituent and the (b) palm kernel oil and/or coconut oil in a total amount of 4.5 wt. %, the soft chew typical includes lauric acid in an amount of 1.34 wt. %, myristic acid in an amount of 0.86 wt. %, palmitic acid in an amount of 1.33 wt. %, stearic acid in an amount of 0.38 wt. %, capric acid in an amount of 0.11 wt. %, and caprylic acid in an amount of 0.08 wt. %, based on the total weight of the soft chew. Lauric acid, capric acid and caprylic acids serve as potential markers for the inclusion of the (a) palm oil and/or palm oil constituent and the (b) palm kernel oil and/or coconut oil in the formulations as they are found in negligible amounts in other oils and raw materials. Table 1 lists the amount of each fatty acid based on the total weight of the soft chew according to example embodiments. The formulations are labeled S1, S2, or S3 in Table 1. The % of Fatty Acids refers to the amount of (a) palm oil and/or palm oil constituent and (b) palm kernel oil and/or coconut oil present in the formulation. The formulations labeled S1 include preferred amounts of the components (a), (b), (c) and other raw materials.

TABLE 1

| Formulation | S3 | S2 | S1 | S1 | S2 | S3 |
|---|---|---|---|---|---|---|
| % of Fatty Acid: | 0.2% | 3.0% | 4.5% | 6.5% | 10.0% | 20.0% |
| % Lauric Acid | 0.06% | 0.89% | 1.34% | 2.75% | 4.24% | 8.47% |
| % Capric | 0.01% | 0.07% | 0.11% | 0.43% | 0.65% | 1.31% |
| % Caprylic | 0.01% | 0.05% | 0.08% | 0.38% | 0.58% | 1.16% |
| % Myristic Acid | 0.04% | 0.57% | 0.86% | 1.47% | 2.25% | 4.51% |
| % Palmitic Acid | 0.06% | 0.88% | 1.33% | 2.25% | 3.45% | 6.91% |
| % Stearic Acid | 0.02% | 0.25% | 0.38% | 1.05% | 1.61% | 3.22% |

As stated above, the soft chew can include numerous different active pharmaceutical ingredients and inactive pharmaceutical ingredients, which vary depending on the purpose of the soft chew. According to example embodiments, the soft chew is formulated to support a dog's cartilage and connective tissue and includes glucosamine hydrochloride and sodium chondroitin sulfate. In other embodiments, the soft chew also contains avocado/soybean unsaponifiables (ASU) powder, methylsulfonylmethane (MSM), Boswella serrata extract, and/or green tea extract as active ingredients. The soft chew may also contain glycerin, lecithin, mixed tocopherols (preservative), natural flavor, rosemary extract, silicon dioxide, soy protein isolate, starch, fish oil, and/or vegetable oil as inactive ingredients. According to another example embodiment, the soft chew is formulated to support cartilage matrix production, inhibit cartilage breakdown, and support joint comfort and includes glucosamine hydrochloride, methylsulfonylmethane, sodium chondroitin sulfate, and omega 3 fatty acids, such as EPA and DHA, as active pharmaceutical ingredients. According to example embodiments, no water is intentionally added to the formula used to manufacture the soft chew, but the soft chew may include up to 10 wt. % moisture.

Another aspect of the invention provides a method of manufacturing the soft chewable nutritional supplements and soft chewable pellets and treats. The method is more efficient than comparative methods used to manufacture soft chews. The method includes mixing the active and inactive pharmaceutical ingredients, for example in a blender to form a dough. The dough is formed into the desired size and shape of the soft chews and soft chewable pellets and treats. Typically, the soft chews are in the short cylinder or cube shape, but size and shape can vary depending on the intended use of the soft chews and chewable pellet and treats. According to an example embodiment, each soft chew weighs 4 grams to 5 grams, for example 4.5 grams.

Instead of fully curing the soft chews before packaging at room temperature or above, which typically takes at least 24 to 72 hours, the method includes a freezing step to harden the soft chews before packaging. The method includes at least partially curing the soft chews at a temperature ranging from −79° C. to 0° C. to increase the firmness of the soft chews and so that they can be placed into a packaging. According to example embodiments, the duration of the curing at the temperature of −79° C. to 0° C. ranges from 5 minutes to 30 minutes. According to other embodiments, the duration ranges from 3 minutes to 2 hours.

After at least partially curing the soft chews at the temperature of −79° C. to 0° C., the method includes packaging the soft chews, typically in a plastic bag, bottle, or tub. The soft chews are typically stored in the packaging at room temperature (18° C. to 26° C.) and continue to cure in the packaging. The soft chews may become fully cured while in the packaging.

Alternatively, the soft chew can be cured using a conventional process for 12 hours to 48 hours at temperature of 18° C. to 26° C. prior to packaging. Typically, the soft chews take 24 to 96 hours to fully cure in the packaging at room temperature.

As stated above, the parameters described above related to the components (a) and (b) impact the processing and curing of the finished soft chew. These parameters include the Mettler Dropping Point of the components (a) and (b); the ratio of the total amount of the components (a) and (b) to the total amount of the (c) other oil present in the soft chew; and the total percentage of the present in the soft chew. These parameters allow the soft chew to achieve the desired texture and firmness using the freezing step to harden soft chew followed by curing in the packaging at room temperature, rather than the conventional longer curing process which includes fully curing the soft chew at room temperature or above.

The foregoing descriptions of various embodiments of the disclosure are provided for purposes of illustration and are not intended to be exhaustive or limiting. Modifications or variations are also possible in light of the above teachings. The embodiments described above were chosen to enable one of ordinary skill in the art to utilize the disclosed disclosures in various embodiments and with various modifications as are suited to the particular use contemplated. All such modifications and variations are within the scope of the disclosure.

What is claimed is:

1. A soft chew for an animal subject, comprising:
(a) at least one of palm oil and palm oil constituent, the palm oil constituent including at least one of stearic acid, palmitic acid, myristic acid, and lauric acid;
(b) at least one of palm kernel oil and coconut oil; and
(c) at least one other oil;
the ratio of the total amount of the components (a) and (b) present in the soft chew to the total amount of the component (c) present in the soft chew ranging from 45:55 to 55:45.

2. The soft chew of claim 1, wherein the combination of the components (a) and (b) have a Mettler Dropping Point ranging from 36° C. to 40° C.

3. The soft chew of claim 1, wherein the components (a) and (b) are present in a total amount of 4.5 weight percent (wt. %) to 6.5 wt. %, based on the total weight of the soft chew.

4. The soft chew of claim 1, wherein the at least one other oil is a vegetable oil or fish oil.

5. A soft chew for an animal subject, comprising:
(a) at least one of palm oil and palm oil constituent, the palm oil constituent including at least one of stearic acid, palmitic acid, myristic acid, and lauric acid;
(b) at least one of palm kernel oil and coconut oil; and
(c) at least one other oil;
the components (a) and (b) being present in a total amount of 4.5 weight percent (wt. %) to 6.5 wt. %, based on the total weight of the soft chew.

6. The soft chew of claim 5 further including glucosamine hydrochloride and sodium chondroitin sulfate.

7. The soft chew of claim 5 further including avocado and soybean unsaponifiables (ASU) powder, methylsulfonylmethane (MSM), Boswella serrata extract, and/or green tea extract.

8. The soft chew of claim 5 further including glucosamine hydrochloride, methylsulfonylmethane, sodium chondroitin sulfate, and omega 3 fatty acids.

9. The soft chew of claim 5, wherein the soft chew includes oil in a total amount of 5 wt. % to 15 wt. %, based on the total weight of the soft chew.

10. The soft chew of claim 5 including at least one of lauric acid, myristic acid, palmitic acid, oleic acid, linoleic acid, stearic acid, capric acid, and caprylic acid.

11. A method of manufacturing a soft chew for an animal subject, wherein the soft chew includes (a) at least one of palm oil and palm oil constituent, the palm oil constituent including at least one of stearic acid, palmitic acid, myristic acid, and lauric acid; (b) at least one of palm kernel oil and coconut oil; and (c) at least one other oil; and comprising the step of:
at least partially curing the soft chew at a temperature of −79° C. to 0° C. before packaging the soft chew.

12. The method of claim 11, wherein the soft chew fully cures while in the packaging.

13. The method of claim 12, wherein the soft chew partially cures at the temperature of −79° C. to 0° C., and the soft chew fully cures a temperature of 18° C. to 26° C. while in the packaging.

14. The method of claim 11, wherein the duration of the curing at the temperature of −79° C. to 0° C. ranges from 5 minutes to 30 minutes.

15. The method of claim 11, wherein the soft chew fully cures after 24 to 72 hours at a temperature of 18° C. to 26° C.

16. The method of claim 11 including, before at least partially curing and packaging the soft chew, mixing the components (a), (b), and (c) with other ingredients to form a mixture; forming the mixture into a dough; and forming the dough into a shape of the soft chew having a weight of 4 to 5 grams.

17. The method of claim 11, wherein the ratio of the total amount of the components (a) and (b) present in the soft chew to the total amount of the component (c) present in the soft chew ranges from 45:55 to 55:45.

18. The method of claim 11, wherein the combination of the components (a) and (b) have a Mettler Dropping Point ranging from 36° C. to 40° C.

19. The method of claim 11, wherein the components (a) and (b) are present in an amount of 4.5 wt. % to 6.5 wt. %, based on the total weight of the soft chew.

20. The method of claim 11, wherein the (c) at least one other oil is a vegetable oil or fish oil.
